(19) United States
(12) Patent Application Publication
(10) Pub. No.: US 2007/0041752 A1
(43) Pub. Date: Feb. 22, 2007

(54) Semiconductive roller

(76) Inventors: Yoshihisa Mizumoto, Hyogo (JP); Noriaki Hitomi, Hyogo (JP); Hirotoshi Murakami, Hyogo (JP); Zhang Yajun, Hyogo (JP)

Correspondence Address: BIRCH STEWART KOLASCH & BIRCH, PO BOX 747, FALLS CHURCH, VA, 22040-0747, US

(21) Appl. No.: 11/495,674

(22) Filed: Jul. 31, 2006

(30) Foreign Application Priority Data
Aug. 8, 2005 (JP) 2005-229663

(51) Int. Cl. F16C 13/00

(52) U.S. Cl. 399/286; 492/56

(57) ABSTRACT

A semiconductive roller comprising a toner-transporting portion whose outermost layer is formed essentially of resin or rubber, wherein the resin or the rubber includes resin or rubber having chlorine atoms and 3 to 60 parts by mass of titanium oxide for 100 parts by mass of the resin or the rubber having the chlorine atoms.

This nonprovisional application claims priority under 35 U.S.C. § 119(a) on Patent Application No(s). 2005-229663 filed in Japan on Aug. 8, 2005, the entire contents of which are hereby incorporated by reference.

### BACKGROUND OF THE INVENTION

1. Field of the Invention

The present invention relates to a semiconductive roller and more particularly to a semiconductive roller, having a toner-transporting portion, which is used as a developing roller, a cleaning roller, a charging roller, and a transfer roller and the like mounted on an electrophotographic apparatus.

2. Description of the Related Art

In recent years, in the printing technique using the electrophotographic method, a high-speed printing operation, formation of a high-quality image, formation of a color image, and miniaturization of image-forming apparatuses have been progressively made and become widespread. Toner holds the key to these improvements. To satisfy the above-described demands, it is necessary to form finely divided toner particles, make the diameters of the toner particles uniform, and make the toner particles spherical. Regarding the technique of forming the finely divided toner particles, toner having a diameter not more than 10 μm and not more than 5 μm have been developed recently. Regarding the technique of making the toner spherical, toner having not less than 99% in its deviation from a spherical form has been developed. To form the high-quality image, polymerized toner has come to be widely used instead of pulverized toner conventionally used. The polymerized toner allows the reproduction of dots to be excellent in obtaining printed sheets from digital information and hence a high-quality printed sheet to be obtained.

In compliance with to the improvement in the technique of forming finely divided toner particles, making the diameters of the toner particles uniform, making the toner particles spherical, and the shift from the pulverized toner to the polymerized toner, in an image-forming apparatus of an electrophotographic apparatus such as a laser beam printer, and the like, a semiconductive roller is useful as a developing roller which imparts a high electrostatic property to toner and is capable of efficiently transporting the toner to an electrophotographic photoreceptor. Users demand that the high-performance function of the semiconductive roller is maintained to the end of the life of a product, for example, the electrophotographic apparatus on which the semiconductive roller is mounted.

To comply with such a demand, as disclosed in Japanese Patent Application Laid-Open No.2004-170845 (patent document 1), the present inventors proposed a conductive rubber roller composed of an ionic-conductive rubber, having a uniform electrical characteristic, to which a dielectric loss tangent-adjusting filler is added to adjust the dielectric loss tangent thereof to 0.1 to 1.5. The conductive rubber roller is capable of imparting a proper and high electrostatic property to toner, thereby providing a high-quality initial image. In the conductive rubber roller, the charged amount of the toner little decreases even after printing on a considerable number of sheets finishes. Consequently the conductive rubber roller keeps providing a high-quality image for a long time.

As disclosed in the patent document 1, a rubber component represented by epichlorohydrin rubber containing chlorine atoms is used for the conductive rubber roller to allow it to be ionic-conductive. In this case, the rubber component containing the chlorine atoms has a high surface free energy. Thus the toner and additive agents to be added to the toner are liable to adhere to the rubber component containing the chlorine atoms.

When the rubber component containing the chlorine atoms polymerized with an ionic-conductive ethylene oxide monomer has a large surface free energy and is liable to get wet. Consequently the adherence of the toner to a semiconductive member becomes high.

When the oxide film is formed on the surface of the semiconductive member by irradiating the surface thereof with ultraviolet rays or exposing it to ozone, the oxygen concentration of the surface of the semiconductive member becomes high. Thus there is a high possibility that the surface free energy increases and hence the adherence of the toner to the semiconductive member becomes higher.

When the dielectric loss tangent of the conductive rubber roller is set to 0.1 to 1.5, the electrostatic property of the toner can be improved and hence the transport amount of the toner can be decreased. Thus the conductive rubber roller provides a high-quality image such as a half-tone image. On the other hand, the amount of the toner deposited on a developing roller decreases. Thus there is a possibility that the adherence of the toner to the developing roller becomes higher.

The toner which has adhered to the semiconductive member does not considerably affect images formed in an early stage and when images are successively printed. But when images are printed in the following conditions, the influence of the toner that has adhered to the semiconductive member cannot be ignored. For example, normally, charged toner is transported to a electrophotographic photoreceptor having an opposite electric charge by an electrostatic force (Coulomb force). But the transport of the toner by the electrostatic force is prevented because the adherence of the toner to the developing roller is high. Thus there arises a problem that the print density becomes low, although the charged amount applied to the toner does not change.

When printing is made on a considerable number of sheets of paper and hence toner has an affinity for a developing roller (for example, image to be printed at 1% is printed on about 2,000 sheets of paper).

When an average particle diameter of toner is not more than 8 μm and particularly not more than 6 μm.

When printing is made not successively, but is suspended all day and made the next day.

When a printer is used in a low-temperature and low-humidity environment in which the charged amount of toner is comparatively large.

When a printer in which the charged amount of toner is set large is used to form a high-quality image.

A developing roller disclosed in Japanese Patent Application Laid-Open No. 2004-271757 (patent document 2) has a blast treated surface. Oxide powder such as titanium oxide powder is attached to the peak portion of the blast treated surface.

In the above developing roller, because the oxide powder is attached to the peak portion of the blast treated surface, the surface roughness is softened and thus the toner is prevented from being overcharged. Consequently the developing roller has an advantage that defective images such as black dots are not formed even in an early stage after an image-forming apparatus having the developing roller mounted thereon is operated.

But as described in claim 4 of the patent document 2, the oxide powder is applied to the blast treated surface and is attached to the peak portions. Further the following description is made at the lines 41 to 42 of the right column of page 2 of the patent document 2: “The surface of the developing sleeve is cut out to some extent and peaks of irregularities are not rough”. Therefore the oxide powder attached to the peak portions of the blast treated surface drops therefrom after the initial stage of the operation of the developing roller and does not display the effect for a long time.

In the patent document 2, no description or suggestion is made on the decrease of the adherence of the toner to the developing roller.

Patent document 1: Japanese Patent Application Laid-Open No. 2004-170845

Patent document 2: Japanese Patent Application Laid-Open No. 2004-271757

### SUMMARY OF THE INVENTION

It is an object of the present invention to provide a semiconductive roller to which toner hardly attaches and in which as a result, a movement of the toner which is made by an electrostatic force is not prevented.

To achieve the object, the present invention provides a toner-transporting portion whose outermost layer is formed essentially of resin or rubber. The above-described resin or rubber includes resin or rubber having chlorine atoms and 3 to 60 parts by mass of titanium oxide for 100 parts by mass of the resin or the rubber having the chlorine atoms.

In the semiconductive roller of the present invention, the outermost layer is formed essentially of resin or rubber. The resin or the rubber composing the outermost layer includes resin or rubber having essentially chlorine atoms.

As the resin or the rubber having the chlorine atoms, known resin or rubber can be used, provided that they have the chlorine atoms. For example, it is possible to use unconductive resin such as chloroprene rubber, chlorinated butyl, chlorosulfonated polyethylene, chlorinated polyethylene, and vinyl chloride or rubber; and conductive resin such as epichlorohydrin copolymers or rubber.

When the unconductive resin or the rubber is used as the resin or the rubber having the chlorine atoms, it is preferable to combine the unconductive resin or the rubber with ionic-conductive resin or rubber to allow the outermost layer to be ionic-conductive. A copolymer containing ethylene oxide can be used as the ionic-conductive resin or the rubber. As the copolymer containing the ethylene oxide, polyether copolymers or epichlorohydrin copolymers can be used.

Even when the conductive resin or the rubber is used as the resin or the rubber having the chlorine atoms, the conductive resin or the rubber may be combined with ionic-conductive resin or rubber not having the chlorine atoms.

The resin or the rubber composing the outermost layer may include resin or rubber other than the above-described resin or rubber. For example, acrylonitrile butadiene rubber (NBR), acrylonitrile rubber, butadiene rubber, styrene butadiene rubber, urethane rubber, butyl rubber, fluororubber, isoprene rubber, silicone rubber, and the like. In addition, it is possible to exemplify low resistance polymers such as allyl glycidyl ether, glycidyl methacrylate, glycidyl acrylate and a bicopolymer of propylene oxide and unsaturated epoxide such as butadiene monoxide. These substances can be used singly or in combination of two or more thereof.

As the resin or the rubber composing the outermost layer, (1) epichlorohydrin copolymer and the following combinations (2) through (4) are favorable: (2) combination of chloroprene rubber, epichlorohydrin copolymer or/and polyether copolymer, (3) combination of chloroprene rubber, NBR, epichlorohydrin copolymer or/and polyether copolymer, (4) combination of chloroprene rubber and NBR. The combination of the chloroprene rubber and the epichlorohydrin copolymer and the combination of the chloroprene rubber, the epichlorohydrin copolymer, and the polyether copolymer are particularly preferable.

When not less than two kinds of resins or rubbers are used in combination as the resin or the rubber composing the outermost layer of the toner-transporting portion, the mixing ratio among them is appropriately selected.

For example, in combining the chloroprene rubber and the epichlorohydrin copolymer with each other, supposing that the total mass of a rubber component is 100, the content of the epichlorohydrin copolymer is set to 5 to 95 parts by mass and favorably 20 to 80 parts by mass; and the content of the chloroprene rubber (C) is set to 5 to 95 parts by mass and favorably 20 to 80 parts by mass.

In combining the chloroprene rubber, the epichlorohydrin copolymer, and the polyether copolymer with one another, supposing that the total mass of the rubber component is 100, the content of the epichlorohydrin copolymer is set to 5 to 90 parts by mass and favorably 10 to 70 parts by mass; the content of the polyether copolymer is set to 5 to 40 parts by mass and favorably 5 to 20 parts by mass; and the content of the chloroprene rubber is set to 5 to 90 parts by mass and favorably 10 to 80 parts by mass. By selecting these mixing ratios, it is possible to disperse the three components favorably and improve the properties such as the strength of the outermost layer. The mass ratio among the epichlorohydrin copolymer, the chloroprene rubber, and polyether copolymer is favorably 2 to 5:4 to 7:1.

As the epichlorohydrin copolymers, it is possible to use epichlorohydrin homopolymer, an epichlorohydrin-ethylene oxide copolymer, an epichlorohydrin-propylene oxide copolymer, an epichlorohydrin-allyl glycidyl ether copolymer, an epichlorohydrin-ethylene oxide-allyl glycidyl ether copolymer, an epichlorohydrin-propylene oxide-allyl glycidyl ether copolymer, and an epichlorohydrin-ethylene oxide-propylene oxide-allyl glycidyl ether copolymer.

It is preferable that the epichlorohydrin copolymer contains the ethylene oxide. It is preferable to use the epichlorohydrin copolymer containing the ethylene oxide at not less than 30 mol % nor more than 95 mol %, favorably not less than 55 mol % nor more than 95 mol %, and more favorably not less than 60 mol % nor more than 80 mol %. The ethylene oxide has an action of decreasing the specific volume resistance of the copolymer. When the ethylene oxide is contained in the copolymer at less than 30 mol %, the ethylene oxide decreases the specific volume resistance of the polymer to a low degree. On the other hand, when the ethylene oxide is contained in the copolymer at not less than 95 mol %, the ethylene oxide crystallizes and thus motions of segments of molecular chains thereof are prevented from taking place. Thereby the specific volume resistance of the copolymer is liable to increase, the hardness of vulcanized rubber increase, and the viscosity of rubber increases before it is vulcanized.

As the epichlorohydrin copolymer, it is especially preferable to use an epichlorohydrin (EP)-ethylene oxide (EO)-allyl glycidyl ether (AGE) copolymer. As the content ratio among the EO, the EP, and the AGE in the epichlorohydrin copolymer, EO:EP:AGE is favorably 30 to 95 mol %:4.5 to 65 mol %:0.5 to 10 mol % and more favorably 60 to 80 mol %:15 to 40 mol %:2 to 6 mol %.

As the epichlorohydrin copolymer, it is also possible to use an epichlorohydrin (EP)-ethylene oxide (EO) copolymer. As the content ratio between the EO and the EP, EO:EP is favorably 30 to 80 mol %:20 to 70 mol % and more favorably 50 to 80 mol %:20 to 50 mol %.

When the resin composing the outermost layer includes the epichlorohydrin copolymer as the resin having the chlorine atom, the mixing amount thereof for 100 parts by mass of the rubber component is favorably not less than 5 parts by mass, more favorably not less than 15 parts by mass, and most favorably not less than 20 parts by mass.

As the polyether copolymers, it is possible to use an ethylene oxide-propylene oxide-allyl glycidyl ether copolymer, an ethylene oxide-allyl glycidyl ether copolymer, propylene oxide-allyl glycidyl ether copolymer, an ethylene oxide-propylene oxide copolymer, and urethane rubber.

It is favorable that the polyether copolymer contains the ethylene oxide. It is more favorable that the polyether copolymer contains the ethylene oxide at 50 to 95 mol %. When the polyether copolymer contains the ethylene oxide at a high percentage, it is possible to stabilize many ions and thus allows the semiconductive rubber composition to have a low electric resistance. But when the polyether copolymer contains the ethylene oxide at a very high percentage, the ethylene oxide crystallizes and the motions of the segments of the molecular chains thereof are prevented from taking place. Consequently there is a possibility that the specific volume resistance of the copolymer increases.

It is preferable that the polyether copolymer contains the allyl glycidyl ether in addition to the ethylene oxide. By copolymerizing the allyl glycidyl ether with the ethylene oxide, the allyl glycidyl ether unit obtains a free volume as a side chain. Thus the crystallization of the ethylene oxide is suppressed. As a result, the semiconductive roller has a lower electric resistance than conventional semiconductive roller. By copolymerizing the allyl glycidyl ether with the ethylene oxide, carbon-to-carbon double bonds are introduced into the copolymer to thereby make it possible to crosslink the copolymer with other rubber. Thereby the polyether copolymer containing the allyl glycidyl ether and the ethylene oxide contributes to the prevention of bleeding and the contamination of an electrophotographic photoreceptor.

It is preferable that the content of the allyl glycidyl ether contained in the polyether copolymer is 1 to 10 mol %. When the content of the allyl glycidyl ether in the polyether copolymer is less than one mol %, bleeding and contamination of the electrophotographic photoreceptor are liable to occur. On the other hand, when the content of the allyl glycidyl ether in the polyether copolymer is more than 10 mol %, it is impossible to enhance the effect of further suppressing the crystallization of the ethylene oxide, and the number of crosslinked points increases after vulcanization. Thus it is impossible to allow the semiconductive roller to have a low electric resistance. In addition, the tensile strength, fatigue characteristic, and flexing resistance thereof deteriorate.

As the polyether copolymer to be used in the present invention, it is preferable to use an ethylene oxide (EO)-propylene oxide (PO)-allyl glycidyl ether (AGE) terpolymer. By copolymerizing the propylene oxide with the ethylene oxide and the allyl glycidyl ether, it is possible to suppress the crystallization of the ethylene oxide to a higher extent. A preferable content ratio among the ethylene oxide (EO), the propylene oxide (PO), and the allyl glycidyl ether (AGE) in the polyether copolymer is EO:PO:AGE=50 to 95 mol %:1 to 49 mol %:1 to 10 mol %. To effectively prevent bleeding from occurring and the electrophotographic photoreceptor from being contaminated, it is preferable that the number-average molecular weight Mn of the ethylene oxide (EO)-propylene oxide (PO)-allyl glycidyl ether (AGE) terpolymer is not less than 10,000.

When the resin composing the outermost layer includes the polyether copolymer, the mixing amount of the polyether copolymer for 100 parts by mass of the rubber component is favorably not less than 5 parts by mass and more favorably not less than 10 parts by mass.

The chloroprene rubber is produced by emulsion polymerization of chloroprene. In dependence on the kind of a molecular weight modifier, the chloroprene rubber is classified into a sulfur-modified type and a sulfur-unmodified type.

The chloroprene rubber of the sulfur-modified type is formed by plasticizing a polymer resulting from polymerization of sulfur and the chloroprene with thiuram disulfide or the like so that the resulting chloroprene rubber of the sulfur-modified type has a predetermined Mooney viscosity. The chloroprene rubber of the sulfur-unmodified type includes a mercaptan-modified type and a xanthogen-modified type. Alkyl mercaptans such as n-dodecyl mercaptan, tert-dodecyl mercaptan, and octyl mercaptan are used as a molecular weight modifier for the mercaptan-modified type. Alkyl xanthogen compounds are used as a molecular weight modifier for the xanthogen-modified type.

In dependence on a crystallization speed of generated chloroprene rubber, the chloroprene rubber is classified into an intermediate crystallization speed type, a slow crystallization speed type, and a fast crystallization speed type.

Both the chloroprene rubber of the sulfur-modified type and the sulfur-unmodified type can be used in the present invention. But it is preferable to use the chloroprene rubber of the sulfur-unmodified type having the slow crystallization speed.

In the present invention, as the chloroprene rubber, it is possible to use rubber or elastomer having a structure similar to that of the chloroprene rubber. For example, it is possible to use copolymers obtained by polymerizing a mixture of the chloroprene and at least one monomer copolymerizable with the chloroprene. As monomers copolymerizable with the chloroprene, it is possible use 2,3-dichloro-1,3-butadiene, 1-chloro-1,3-butadiene, sulfur, styrene, acrylonitrile, methacrylonitrile, isoprene, butadiene, acrylic acid, methacrylic acid, and esters thereof.

When the rubber composing the outermost layer includes chloroprene rubber as the rubber having the chlorine atom, the mixing amount of the chloroprene rubber can be appropriately selected in the range of 1 to 100 parts by mass for 100 parts by mass of the rubber component. But in view of the effect of imparting electrostatic property to the semiconductive roller, the mixing amount of the chloroprene rubber is favorably not less than 5 and more favorably not less than 10 for 100 parts by mass of the rubber component to uniformly form the rubber. The mixing amount of the chloroprene rubber is favorably not more than 80 and more favorably not more than 60 for 100 parts by mass of the rubber component.

As the NBR, it is possible to use any of low-nitrile NBR containing the acrylonitrile at not more than 25%, medium-nitrile-NBR containing the acrylonitrile in the range of 25 to 31%, midium-high-nitrile containing the acrylonitrile in the range of 31 to 36%, and high-nitrile NBR containing the acrylonitrile at not less than 36%.

In the present invention, to reduce the specific gravity of the rubber, it is preferable to use the low-nitrile NBR having a small specific gravity. To mix the NBR and the chloroprene rubber with each other favorably, it is preferable to use the intermediate-nitrile NBR or the low-nitrile NBR. More specifically, to make the solubility parameter of the chloroprene rubber and that of the NBR close to each other, the content of the acrylonitrile in the NBR is favorably 15 to 39%, more favorably 17 to 35%, and most favorably 20 to 30%.

When the rubber composing the outermost layer includes NBR as the rubber, the content of the NBR for 100 parts by mass of the rubber component is favorably in the range of 5 to 65 parts by mass, more favorably in the range of 10 to 65 parts by mass, and most favorably in the range of 20 to 50 parts by mass. If the content of the NBR is more than 65, the charged amount of toner decreases. Thus it is preferable that the content of the NBR is not more than 65. It is preferable that the content of the NBR is not less than 5 to suppress an increase of the hardness of the semiconductive rubber composition and substantially obtain the effect of decreasing the dependence of the semiconductive rubber composition on temperature.

In the semiconductive roller of the present invention, the resin or the rubber composing the outermost layer contains 3 to 60 parts by mass of titanium oxide for 100 parts by mass of the resin or the rubber having the chlorine atoms.

The titanium oxide used in the present invention is not specifically limited, but known titanium oxide can be used. As a crystal system, it is possible to use an anatase type, a rutile type, a mixed type of these two types, and an amorphous type. It is particularly preferable to use the titanium oxide of the rutile type. The titanium oxide is obtained by using a sulfuric acid method, a chlorine method, low-temperature oxidizing (thermal decomposition and hydrolysis) of volatile titanium compounds such as titanium alcoxide, titanium halide or titanium acetylacetonate.

It is preferable that the titanium oxide that is used in the present invention includes particles whose diameters are not more than 0.5 μm at not less than 50%. At this ratio, the titanium oxide has a favorable dispersibility. It is particularly favorable to use the titanium oxide whose average particle diameter is 0.1 to 0.5 μm.

The reason the resin or the rubber composing the outermost layer contains 3 to 60 parts by mass of titanium oxide for 100 parts by mass of the resin or the rubber having the chlorine atoms is as follows: If the mixing amount of the titanium oxide is less than 3 parts by mass, it is difficult to display the effect of the titanium oxide of decreasing the adherence of the toner to the semiconductive roller. On the other hand, if the mixing amount of the titanium oxide is more than 60 parts by mass, the hardness of the outermost layer of the toner-transporting portion 1 becomes too high or the toner cannot be appropriately charged. It is more favorable that the mixing amount of the titanium oxide is in the range of 5 to 60 parts by mass.

The semiconductive roller of the present invention is semiconductive. More specifically, the electric resistance of the semiconductive roller is favorably in the range of 10⁵ to 10⁸ Ω and more favorably in the range of 10⁵ to 10⁷ Ω, when a voltage of 100 volts is applied thereto.

It is favorable that the electric resistance of the semiconductive roller is not less than 10⁵ Ω to suppress the generation of a low-quality image by controlling electric current flowing therethrough and prevent electrical discharge to the electrophotographic photoreceptor. It is also favorable that the electric resistance of the semiconductive roller is not more than 10⁸ Ω to keep efficient toner supply and prevent a voltage drop of the developing roller when the toner moves to the electrophotographic photoreceptor. Thereby it is possible to prevent generation of a defective image because the toner can be securely transported from the developing roller to the electrophotographic photoreceptor. When the electric resistance of the semiconductive roller is not more than 10⁷ Ω, the semiconductive roller can be used in various conditions. The electric resistance of the roller is measured by a method described in the examples that will be described later.

Conductivity is classified into electroconductivity and ionic conductivity. It is preferable that the outermost layer of the toner-transporting portion is ionic-conductive because the outermost layer can be provided with a uniform electrical characteristic.

When ionic-conductive resin or rubber is included in the resin or the rubber composing the outermost layer of the toner-transporting portion, it is possible to make the resin or the rubber composing the outermost layer ionic-conductive by adjusting the mixing amount of the ionic-conductive resin or rubber. Ionic-conductive agents which are described below may be used in combination with the resin or the rubber showing the ionic conductivity.

When the ionic-conductive resin or rubber is not included in the resin or the rubber composing the outermost layer of the toner-transporting portion, the ionic-conductive agent is added to the resin or the rubber composing the outermost layer of the toner-transporting portion.

Various ionic-conductive agents can be selectively used. For example, it is possible to use anion-containing salts having a fluoro group (F—) and a sulfonyl group (—SO₂—). More specifically, it is possible to use salts of bisfluoroalkylsulfonylimide, salts of tris(fluoroalkylsulfonyl)methane, and salts of fluoroalkylsulfonic acid. As cations of the above-described salts making a pair with the anions, those of metal ions of the alkali metals, the group 2A, and other metals are favorable. A lithium ion is more favorable. As the ionic-conductive agents, it is possible to list LiCF₉SO₃, LiN(SO₂CF₃)₂, LiC(SO₂CF₃), LiCH(SO₂CF₃)₂, and LiSF₆CF₂SO₃.

The mixing amount of the ionic-conductive agent can be appropriately selected in dependence on the kind thereof. For example, it is preferable that the mixing amount of the ionic-conductive agent is 0.1 to 5 parts by mass for 100 parts by mass of the rubber component.

An electro-conductive agent may be added to the rubber component as desired to allow the semiconductive roller to be electronic-conductive. As the electro-conductive agent, it is possible to use conductive carbon black such as Ketchen black, furnace black, acetylene black; conductive metal oxides such as zinc oxide, potassium titanate, antimony-doped titanium oxide, tin oxide, and graphite; and carbon fibers. The mixing amount of the electro-conductive agent is appropriately selected in consideration of properties such as the electric resistance of the semiconductive roller. For example, the mixing amount of the electro-conductive agent is 5 to 20 parts by mass for 100 parts by mass of the rubber component.

To impart a high electrostatic property to the toner and keep the electrostatic property for a long time, it is preferable that the dielectric loss tangent of the semiconductive roller of the present invention is favorably in the range of 0.1 to 1.8, when an alternating voltage of 5V is applied thereto at a frequency of 100 Hz.

In the electrical characteristics of the semiconductive roller, the dielectric loss tangent means an index indicating the flowability of electricity (conductivity) and the degree of influence of a capacitor component (electrostatic capacity) In other words, the dielectric loss tangent is a parameter indicating a phase delay when an alternating current is applied to the semiconductive roller, namely, a rate of the capacitor component when a voltage is applied thereto. That is, the dielectric loss tangent is indicated by a charged amount generated when the toner contacts the developing roller at a high voltage by an amount regulation blade and a charged amount which escapes to the semiconductive roller before the toner is transported to the electrophotographic photoreceptor. Thus the dielectric loss tangent is an index showing the charged amount immediately before the toner contacts the electrophotographic photoreceptor.

When the dielectric loss tangent is large, it is easy to flow electricity (electric charge) through the roller, which makes the progress of polarization slow. On the other hand, when the dielectric loss tangent is small, it is not easy to flow electricity (electric charge) through the roller, which makes the progress of the polarization fast. Thus when the dielectric loss tangent is small, the roller has a high capacitor-like characteristic and it is possible to maintain an electric charge on the toner generated by frictional charge without escaping the electric charge from the roller. That is, it is possible to obtain the effect of imparting the electrostatic property to the toner and maintaining the electrostatic property imparted thereto. To obtain the effect, the dielectric loss tangent is set to not more than 1.8. To prevent the print density from becoming too low owing to an increase of the charged amount to a very high extent and prevent the semiconductive rubber composition from becoming hard owing to the addition of much admixtures used to adjust the dielectric loss tangent, the dielectric loss tangent is set to not less than 0.1.

The dielectric loss tangent is more favorably not less than 0.3 and most favorably not less than 0.5. The dielectric loss tangent is favorably not more than 1.5, more favorably not more than 1.0, and most favorably not more than 0.8.

The dielectric loss tangent is measured by a method adopted in the examples which will be described later.

The reason a slight voltage of 5V is applied to the semiconductive roller as the condition of measuring the dielectric loss tangent is as follows: Supposing that when the semiconductive roller used as a developing roller holds toner thereon or when the toner is transported to the electrophotographic photoreceptor, a very small voltage fluctuation occurs.

The frequency of 100 Hz is suitable in consideration of the number of rotations of the developing roller and nips between the developing roller and the electrophotographic photoreceptor, the blade, and a toner supply roller with which the developing roller contacts or to which the developing roller is proximate.

To control the dielectric loss tangent of the semiconductive roller so that the semiconductive roller has the dielectric loss tangent in the above-described predetermined range, a dielectric loss tangent-adjusting agent is added to the resin or the rubber composing the outermost layer. As the dielectric loss tangent-adjusting agent, weakly conductive carbon black or calcium carbonate treated with fatty acid is used. It is preferable to use the weakly conductive carbon black. When the calcium carbonate treated with the fatty acid is used, it is so compatible with the titanium oxide that the calcium carbonate partly aggregates. Consequently there is a possibility that the calcium carbonate grows into particles having large diameters and the dispersibility thereof deteriorates. On the other hand, the weakly conductive carbon black has an affinity for the titanium oxide in dispersibility.

The weakly conductive carbon black is large in its particle diameter, has a low extent of development in its structure, and has a small degree of contribution to the conductivity of the semiconductive rubber composition. The semiconductive rubber composition containing the weakly conductive carbon black is capable of obtaining a capacitor-like operation owing to a polarizing action without increasing the conductivity thereof and controlling the electrostatic property thereof without deteriorating the uniformity of the electric resistance thereof.

It is possible to efficiently obtain the above-described effect by using the weakly conductive carbon black whose primary particle diameter is not less than 80 nm and preferably not less than 100 nm. When the primary particle diameter is not more than 500 nm and preferably not more than 250 nm, it is possible to remarkably reduce the degree of the surface roughness of the outermost layer. It is preferable that the weakly conductive carbon black is spherical or has a configuration similar to the spherical shape because the weakly conductive carbon black has a small surface area.

Various weakly conductive carbon blacks can be selected. For example, it is favorable to use carbon black produced by a furnace method or a thermal method providing particles having large diameters. It is more favorable to use the carbon black produced by the furnace method. SRF carbon, FT carbon, and MT carbon are preferable in terms of the classification of carbon. The carbon black for use in pigment may be used.

It is preferable to use not less than five parts by mass of the weakly conductive carbon black for 100 parts by mass of the rubber component so that the weakly conductive carbon black substantially displays the effect of reducing the dielectric loss tangent of the semiconductive rubber composition. It is preferable to use not more than 70 parts by mass of the weakly conductive carbon black for 100 parts by mass of the rubber component to prevent an increase of the hardness of the semiconductive rubber composition so that the semiconductive roller composed of the semiconductive rubber composition does not damage other members which contact the semiconductive roller and prevent a decrease of the wear resistance thereof. It is preferable that the mixing amount of the weakly conductive carbon black is not more than 70 parts by mass for 100 parts by mass of the rubber component to allow the semiconductive roller to have a small voltage fluctuation for a voltage applied thereto, namely, to allow the semiconductive roller to be ionic-conductive.

In view of the mixing property of the weakly conductive carbon black with other components, the mixing amount of the weakly conductive carbon black is favorably 10 to 60 parts by mass and most favorably 25 to 55 parts by mass for 100 parts by mass of the rubber component.

The calcium carbonate treated with the fatty acid is more active than ordinary calcium carbonate because the fatty acid is present on the interface of the calcium carbonate and is lubricant. Thus a high degree of the dispersion of the calcium carbonate treated with the fatty acid can be realized easily and reliably. When the polarization action is accelerated by the treatment of the calcium carbonate with the fatty acid, there is an increase in the capacitor-like operation in the rubber owing to the above-described two actions. Thus the dielectric loss tangent of the semiconductive rubber composition can be efficiently reduced. It is preferable that the surfaces of particles of the calcium carbonate treated with fatty acid are entirely coated with the fatty acid such as stearic acid.

It is preferable that the mixing amount of the calcium carbonate treated with fatty acid is 30 to 80 parts by mass and more favorably 40 to 70 parts by mass for 100 parts by mass of the rubber component. It is preferable that the mixing amount of the calcium carbonate treated with fatty acid is not less than 30 parts by mass for 100 parts by mass of the rubber component so that it substantially displays the effect of reducing the dielectric loss tangent of the semiconductive rubber composition. To prevent the rise of the hardness of the semiconductive rubber composition and the fluctuation of the electric resistance thereof, it is preferable that the mixing amount of the calcium carbonate treated with fatty acid is not more than 80 parts by mass for 100 parts by mass of the rubber component.

It is preferable that an oxide film is formed on the surface of the outermost layer of the semiconductive roller of the present invention. The oxide film serves as a dielectric layer and is capable of decreasing the dielectric loss tangent of the semiconductive roller. Thereby the dielectric loss tangent can be controlled in a predetermined range. The oxide film also serves as a low-frictional layer. Thereby toner separates easily from the outermost layer. Hence images can be formed easily. Consequently images of high quality can be obtained.

It is preferable that the oxide film has a large number of C═O groups or C—O groups. The oxide film is formed by irradiating the surface of the outermost layer with ultraviolet rays and/or ozone and oxidizing the surface of the outermost layer. It is preferable to form the oxide film by irradiating the surface of the outermost layer with ultraviolet rays because the use of the ultraviolet rays allows a treating period of time to be short and the oxide film-forming cost to be low.

The treatment for forming the oxide film can be made in accordance with a known method. For example, the surface of the outermost layer is irradiated with ultraviolet rays having a wavelength of 100 nm to 400 nm and favorably 100 nm to 300 nm for 30 seconds to 30 minutes and favorably one to 10 minutes while the semiconductive roller is being rotated, although the intensity of the ultraviolet rays varies according to the distance between the surface of the rubber roller and an ultraviolet ray irradiation lamp and the kind of rubber. It is necessary to select the intensity of ultraviolet ray and irradiation condition (time, temperature inside tank, and distance) in conformity to a condition in which the dielectric loss tangent can be adjusted to a range specified in the present invention.

When the surface of the outermost layer is irradiated with the ultraviolet ray, the content of rubber which is liable to be deteriorated with the ultraviolet ray is preferably not more than 50 parts by mass for 100 parts by mass of the rubber component. When the surface of the outermost layer is irradiated with the ultraviolet ray, it is very effective to add chloroprene and chloroprene rubber to the rubber component.

Supposing that the electric resistance of the semiconductive roller is R50 when a voltage of 50V is applied thereto before the oxide film is formed thereon and that the electric resistance thereof is R50a when the voltage of 50V is applied thereto after the oxide film is formed thereon, it is favorable that log(R50a)−log(R50)=0.2 to 1.5. By setting the electric resistance of the semiconductive roller to the above-described range, it is possible to provide the semiconductive roller with improved durability, reduce a variation of the electric resistance when it is in operation, reduce a stress on toner, and prevent the electrophotographic photoreceptor from being contaminated or damaged. Because the index value of the electric resistance of the semiconductive roller is set to a low voltage of 50 volts at which a voltage is stably applied thereto, it is possible to capture a slight rise of the electric resistance caused by the formation of the oxide film. The lower limit value of log(R50a)−log(R50) is more favorably 0.3 and most favorably 0.5. The upper limit value of log(R50a)−log(R50) is more favorably 1.2 and most favorably 1.0.

It is preferable that the friction coefficient of the surface of the semiconductive roller is favorably in the range of 0.1 to 1.0, more favorably in the range of 0.1 to 0.8, and most favorably in the range of 0.1 to 0.6. In this range, it is possible to improve the electrostatic property of the toner and prevent the toner from adhering to the surface of the semiconductive roller. If the friction coefficient of the semiconductive roller is more than 1.0, a large stress such as a large shearing force is applied to the toner. Further, a portion of the semiconductive roller making a sliding contact with other members of an image-forming apparatus has a high calorific value and a large amount of wear owing to friction therebetween. On the other hand, if the friction coefficient of the semiconductive roller is less than 0.1, the toner slips and hence it is difficult to transport a sufficient amount of the toner and sufficiently charge the toner.

With reference to FIG. 4, the friction coefficient of a semiconductive roller 43 was measured by substituting a numerical value measured with a digital force gauge 41 of an apparatus into the Euler's equation. The apparatus has a digital force gauge (Model PPX-2T) manufactured by Imada Co.,Ltd.) 41, a friction piece (commercially available OHP film, made of polyester, in contact with the peripheral surface of the semiconductive roller 43 in an axial length of 50 mm) 42, a weight 44 weighing 20 g, and the semiconductive roller 43.

The surface roughness Rz of the semiconductive roller of the present invention is favorably not more than 10 μm and more favorably not more than 8 μm. By setting the surface roughness Rz of the semiconductive roller to the above-described range, the diameters of concave and convex portions of the surface thereof are smaller than those of toner particles. Thus the toner having a uniform diameter can be transported, and the flowability of the toner is favorable. Consequently it is possible to efficiently impart electrostatic property to the toner. It is preferable that the surface roughness Rz is small but is normally not less than 1 μm. When the surface roughness Rz is less than 1 μm, it is difficult to transport the toner.

The surface roughness Rz is measured in conformity to JIS B 0601 (1994).

The semiconductive roller of the present invention has the toner-transporting portion having a function of transporting the toner held on the surface thereof. The amount of the toner to be transported by the semiconductive roller of the present invention is not specifically limited, but it is preferable that the semiconductive roller transports the toner in an amount of 0.01 to 1.0 mg/cm².

The construction of the toner-transporting portion is not specifically limited, provided that it has the outermost layer satisfying the above-described conditions. The toner-transporting portion may have a multi-layer construction such as a two-layer construction in dependence on demanded performance. But it is preferable that the toner-transporting portion has only one outermost layer. Thereby the toner-transporting portion having one-layer has little variations in the properties thereof and can be manufactured at a low cost.

It is preferable that the semiconductive roller of the present invention has a sealing member for preventing leak of the toner. The “sealing member” includes not only the one provided to prevent the leak of the toner, but also members that slidingly contact the peripheral surface of the semiconductive roller.

It is preferable that the toner-sealing portion contains the dielectric loss tangent-adjusting agent to set the dielectric loss tangent to 0.1 to 1.8.

It is preferable that the semiconductive roller of the present invention is used for an image-forming mechanism of an electrophotographic apparatus of office automation appliances such as a laser beam printer, an ink jet printer, a copying machine, a facsimile, and the like or an ATM.

Above all, the semiconductive roller of the present invention is preferably used as a developing roller for transporting unmagnetic one-component toner to the electrophotographic photoreceptor. Roughly classifying the developing method used in the image-forming mechanism of the electrophotographic apparatus in the relation between the electrophotographic photoreceptor and the developing roller, the contact type and the non-contact type are known. The semiconductive roller of the present invention can be utilized in both types. It is preferable that the semiconductive roller of the present invention used as the developing roller contacts the electrophotographic photoreceptor.

In addition to the developing roller, the semiconductive roller of the present invention can be used as a charging roller for uniformly charging an electrophotographic drum, a transfer roller for transferring a toner image from the electrophotographic photoreceptor to a transfer belt and paper, a toner supply roller for transporting toner, and a cleaning roller for removing residual toner.

In the present invention, even when a rubber component, containing chlorine atoms, which has a high surface free energy is used to allow the semiconductive roller to be ionic-conductive, it is possible to decrease the adherence of the toner to the semiconductive roller of the present invention by adding a predetermined amount of the titanium oxide to the rubber component.

The effect of decreasing the adherence of the toner to the semiconductive roller, which is brought about by the addition of the titanium oxide to the rubber component is not affected by the kind and composition of the rubber component, whether or not the oxide film is formed on the surface of the outermost layer, the property (particularly dielectric loss tangent) of the semiconductive roller, environment, and a situation of printing, but can be kept for a long time even at a time when the toner is relatively compatible with the semiconductive roller.

Consequently when the semiconductive roller of the present invention is used as the developing roller of the image-forming mechanism of the electrophotographic apparatus, the developing roller allows a printed sheet to have a stable concentration without dropping a print density.

### BRIEF DESCRIPTION OF THE DRAWINGS

FIG. 1 is a schematic view showing a semiconductive roller of the present invention.

FIG. 2 shows a method of measuring the electric resistance of the semiconductive roller of the present invention

FIG. 3 shows a method of measuring the dielectric loss tangent of the semiconductive roller of the present invention.

FIG. 4 shows a method of measuring the friction coefficient of the semiconductive roller of the present invention.

### DETAILED DESCRIPTION OF THE PREFERRED EMBODIMENTS

The embodiments of the present invention will be described below with reference to the drawings.

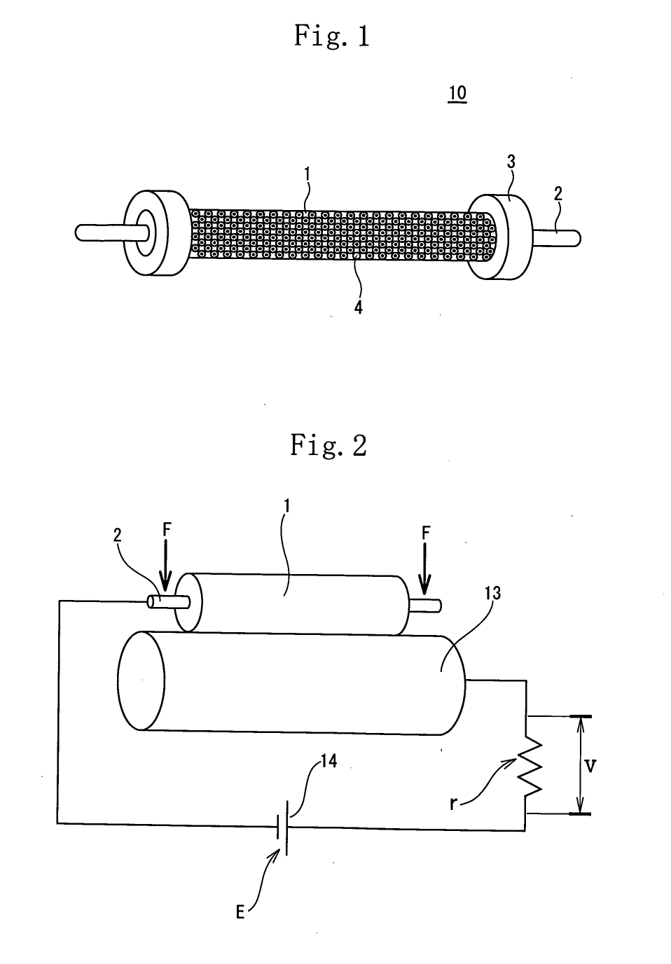

As shown in FIG. 1, a semiconductive roller 10 used as a developing roller has a cylindrical toner-transporting portion 1 having a thickness of 0.5 mm to 15 mm, favorably 3 to 8 mm, a columnar metal shaft 2 inserted into a hollow portion of the semiconductive roller 10 by press fit, and a pair of annular sealing portions 3 for preventing leak of a toner 4. The toner-transporting portion 1 and the metal shaft 2 are bonded to each other with a conductive adhesive agent. The reason the thickness of the toner-transporting portion 1 is set to 0.5 mm to 15 mm is as follows: If the thickness of the toner-transporting portion 1 is less than 0.5 mm, it is difficult to obtain an appropriate nip. If the thickness of the toner-transporting portion 1 is more than 15 mm, the toner-transporting portion 1 is so large that it is difficult to reduce the size and weight of an apparatus in which the developing roller 10 is mounted. An oxide film is formed on the outermost layer of the toner-transporting portion 1.

The metal shaft 2 is made of metal such as aluminum, aluminum alloy, SUS and iron or ceramics.

The sealing portion 3 is made of nonwoven fabric such as Teflon (registered trade mark) or a sheet.

The semiconductive roller of the present invention can be produced by carrying out a conventional method.

The method of producing the semiconductive roller 10 shown in FIG. 1 is described below.

After components constructing the toner-transporting portion 1 are kneaded by using a Banbury mixer, a mixture thereof is tubularly preformed by using a rubber extruder. After the preformed tube is vulcanized at 160° C. for 15 to 70 minutes, a metal shaft 2 is inserted into a hollow portion of the tube, bonded thereto, and the surface thereof is polished. After the tube is cut to a predetermined size, it is polished appropriately so that it is roller-shaped. The optimum vulcanizing time period should be set by using a vulcanization testing rheometer (for example, Curelastmeter). The vulcanization temperature may be set around 160° C. in dependence on necessity. To suppress the contamination of the electrophotographic photoreceptor and the like and reduce the degree of the compression set of the semiconductive rubber composition, it is preferable to set conditions by which a vulcanization amount is obtained to a possible highest extent. A conductive foamed roller may be formed by adding a blowing agent to the rubber component.

After the roller is washed with water, an oxide film is formed on the surface of the outermost layer. More specifically, by using an ultraviolet ray irradiation lamp, the surface of the outermost layer is irradiated with ultraviolet rays (wavelength: 184.9 nm and 253.7 nm) at intervals of 90 degrees in its circumferential direction for five minutes and with the ultraviolet ray irradiation lamp spaced at 10 cm from the semiconductive roller 10. The roller is rotated by 90 degrees four times to form the oxide film on its entire peripheral surface (360 degrees).

As the components composing the toner-transporting portion 1, resin or rubber having chlorine atoms, titanium oxide, a dielectric loss tangent-adjusting agent, a vulcanizing agent, and a acid-accepting agent are used. As desired, resin or rubber not having the chlorine atoms may be added to the rubber component.

As the resin or the rubber having the chlorine atoms, the epichlorohydrin copolymer and the chloroprene rubber are used in combination. Supposing that the total mass of the rubber component is 100 parts by mass, the content of the epichlorohydrin copolymer is 25 to 50 parts by mass and that of the chloroprene rubber is 50 to 75 parts by mass.

As the epichlorohydrin copolymer, the ethylene oxide-epichlorohydrin-allyl glycidyl ether terpolymer is used. The content ratio among the ethylene oxide, the epichlorohydrin, and the allyl glycidyl ether is 60 to 80 mol %:15 to 40 mol %:2 to 6 mol %.

As the chloroprene rubber, chloroprene rubber not containing sulfur is used.

The polyether copolymer is added to the rubber component as desired as the resin or the rubber not having the chlorine atoms.

As the polyether copolymer, the ethylene oxide-propylene oxide-allyl glycidyl ether terpolymer is used. The content ratio among the ethylene oxide, the propylene oxide, and the allyl glycidyl ether is 80 to 95 mol %:l to 10 mol %:l to 10 mol %. The number-average molecular weight Mn of the copolymer is favorably not less than 10,000, more favorably not less than 30,000, and most favorably not less than 50,000.

When the polyether copolymer is added to the rubber component, the mixing ratio of the epichlorohydrin copolymer, the polyether copolymer, and the chloroprene rubber for the total mass of the rubber components, namely, 100 parts by mass are 15 to 40 parts by mass, 5 to 20 parts by mass, and 40 to 80 parts by mass respectively.

As the titanium oxide, titanium oxide of the rutile type is used. It is preferable to use the titanium oxide composed mainly of particles having diameters of 0.3 to 0.5 μm and an average particle diameter of 0.3 to 0.5 μm.

5 to 60 parts by mass of the titanium oxide is used for 100 parts by mass of the resin or the rubber having the chlorine atoms.

The weakly conductive carbon black is used as the dielectric loss tangent-adjusting agent. It is preferable to use the weakly conductive carbon black which has a primary particle diameter of 100 to 250 nm and is spherical or nearly spherical. It is preferable to use the weakly conductive carbon black having an iodine absorption amount of 10 to 40 mg/g and favorably 10 to 30 mg/g and a DBP oil absorption amount of 25 to 90 ml/100 g and favorably 25 to 55 ml/100 g. The mixing amount of the weakly conductive carbon black is set to 20 to 70 parts by mass for 100 parts by mass of the rubber component.

As the vulcanizing agent, it is possible to use a sulfur-based vulcanizing agent, a thiourea-based vulcanizing agent, triazine derivatives, peroxides, and monomers. These vulcanizing agents can be used singly or in combination of two or more of them. As the sulfur-based vulcanizing agent, it is possible to use powdery sulfur, organic sulfur-containing compounds such as tetramethylthiuram disulfide, N,N-dithiobismorpholine, and the like. As the thiourea-based vulcanizing agent, it is possible to use tetramethylthiourea, trimethylthiourea, ethylenethiourea, and thioureas shown by (CₙH₂ₙ₊₁NH)₂C═S (n=integers 1 to 10). As the peroxides, benzoyl peroxide is exemplified.

The mixing amount of the vulcanizing agent for 100 parts by mass of the rubber component is favorably not less than 0.2 parts by mass nor more than five parts by mass and more favorably not less than one part by mass nor more than three parts by mass.

In the present invention, it is preferable to use sulfur and thioureas in combination as the vulcanizing agent.

The mixing amount of the sulfur for 100 parts by mass of the rubber component is favorably not less than 0.1 parts by mass nor more than 5.0 parts by mass and more favorably not less than 0.2 parts by mass nor more than 2 parts by mass. When the mixing amount of the sulfur for 100 parts by mass of the rubber component is less than 0.1 parts by mass, the vulcanizing speed of the entire rubber composition is slow and thus the productivity thereof is low. On the other hand, when the mixing amount of the sulfur for 100 parts by mass of the rubber component is more than 5.0 parts by mass, there is a possibility that the compression set of the rubber composition is high and the sulfur and a vulcanization accelerator bloom.

The mixing amount of the thioureas for 100 g of the rubber component is favorably not less than 0.0009 mol nor more than 0.0800 mol and more favorably not less than 0.0015 mol nor more than 0.0400 mol. By mixing the thioureas with the rubber component in the above-described range, blooming and the contamination of the electrophotographic photoreceptor hardly occur, and further a molecular motion of the rubber is hardly interfered. Thus the rubber composition is allowed to have a low electric resistance. As the addition amount of the thioureas is increased to increase the crosslinking density, the electric resistance of the rubber composition can be decreased. That is, when the mixing amount of the thioureas for 100 g of the rubber component is less than 0.0009 mol, it is difficult to improve the compression set of the rubber composition and decrease the electric resistance thereof. On the other hand, when the mixing amount of the thioureas for 100 g of the rubber component is more than 0.0800 mol, the thioureas bloom from the surface of the rubber composition and contaminate the electrophotographic photoreceptor and it liable to deteriorate the mechanical properties of the rubber composition such as the breaking extension thereof extremely.

In dependence on the kind of the vulcanizing agent, a vulcanization accelerator or a vulcanization accelerator assistant agent may be added to the rubber component.

As the vulcanization accelerator, it is possible to use inorganic accelerators such as slaked lime, magnesia (MgO), and litharge (PbO); and organic accelerators shown below. The organic accelerator includes guahidines such as di-ortho-tolylguanidine, 1,3-diphenyl guanidine, 1-ortho-tolylbiguanide, salts of the di-ortho-tolylguanidine of dicatechol borate; thiazoles such as 2-mercapto-benzothiazole, dibenzothiazyl disulfide; sulfenamides such as N-cyclohexyl-2-benzothiazolylsulfenamide; thiurams such as tetramethylthiuram monosulfide, tetramethylthiuram disulfide, tetraethylthiuram disulfide, and dipentamethylenethiuram tetrasulfide; and thioureas. It is possible to use the above-described substances singly or in combination.

The mixing amount of the vulcanization accelerator is favorably not less than 0.5 nor more than five parts by mass and more favorably not less than 0.5 nor more than two parts by mass for 100 parts by mass of the rubber component.

The following vulcanization accelerator assistants can be used: metal oxides such as zinc white; fatty acids such as stearic acid, oleic acid, cotton seed fatty acid, and the like; and known vulcanization accelerator assistants.

The addition amount of the vulcanization accelerator for 100 parts by mass of the rubber component is favorably not less than 0.5 parts by mass nor more than 10 parts by mass and more favorably not less than two parts by mass nor more than eight parts by mass.

The semiconductive rubber composition of the present invention contains an acid-accepting agent because the semiconductive rubber composition contains the resin or the rubber having the chlorine atoms. By using the semiconductive rubber composition containing the acid-accepting agent, it is possible to prevent chlorine gas generated in a vulcanizing operation from remaining behind and the electrophotographic photoreceptor from being contaminated.

As the acid-accepting agent, it is possible to use various substances acting as acid acceptors. As the acid-accepting agent, hydrotalcites or magnesium oxide can be favorably used because they have preferable dispersibility. The hydrotalcites are especially favorable. It is possible to obtain a high acid-accepting effect by using the hydrotalcites in combination with a magnesium oxide or a potassium oxide. Thereby it is possible to securely prevent the electrophotographic photoreceptor from being contaminated.

The mixing amount of the acid-accepting agent for 100 parts by mass of the rubber component is favorably not less than 1 nor more than 10 parts by mass and more favorably not less than 1 nor more than 5 parts by mass. The mixing amount of the acid-accepting agent for 100 parts by mass of the rubber component is favorably not less than one part by weight to allow the acid-accepting agent to effectively display the effect of preventing a vulcanizing operation from being inhibited and the electrophotographic photoreceptor from being contaminated. The mixing amount of the acid-accepting agent for 100 parts by mass of the rubber component is favorably not more than 10 parts by mass to prevent the hardness of the semiconductive rubber composition from increasing.

It is preferable that the toner-transporting portion 1 contains alumina in addition to the above-described components. By using the alumina having a high thermal conductivity for the toner-transporting portion 1, it is possible to quickly disperse heat generated by the friction between the sealing portion 3 and the peripheral surface of the toner-transporting portion 1 to the entire toner-transporting portion. Thus heat transmitted to the inside of the toner-transporting portion 1 can be escaped to the outside via the metal shaft 2 made of metal and also dissipated from the surface of the toner-transporting portion 1 containing the alumina. Therefore it is possible to suppress the wear of the sealing portion 3 accelerated by the heat generated by the sliding friction between the sealing portion 3 and the toner-transporting portion 1. Thereby it is effectively prevent the leak of the toner for a long time. Further because the toner-transporting portion 1 is not heated to a high temperature by the heat generated at the sliding-contact portion, it is possible to prevent thermoplastic resin composing the polymerized toner from melting and particles thereof from becoming large in its diameter or edged and thereby adhering to each other and becoming angular. Thereby it is possible to improve the durability of the sealing portion 3 and the toner-transporting portion 1 to a very high extent. Further by adding the alumina to the rubber component, the mixing efficiency of the titanium oxide increases. For example, the titanium oxide is hardly detected on the surface of the rubber as a foreign matter.

The alumina is an oxide (Al₂O₃) of aluminum. It is favorable that 3 to 50 parts by mass of the alumina is added to 100 parts by mass of the rubber component. It is more favorable that 5 to 30 parts by mass of the alumina is added to 100 parts by mass of the rubber component and most favorable that 8 to 25 parts by mass of the alumina is added to 100 parts by mass of the rubber component. The reason the content of the alumina is set to 3 to 50 parts by mass is as follows: If the content of the alumina is less than 3 parts by mass, it is difficult to obtain the effect of escaping heat generated by the sliding friction between the sealing portion 3 and the toner-transporting portion 1. On the other hand, if the content of the alumina is more than 50 parts by mass, the toner-transporting portion 1 becomes too hard owing to an increase of the hardness thereof, and deterioration of the toner is accelerated. Further the durability of an abrasive material for abrading the surface of the toner-transporting portion 1 becomes low. Thus it is necessary to re-dress the abrasive material. By setting the content of the alumina to not more than 30 parts by mass, the alumina and a filler for adjusting the dielectric loss tangent favorably mix with each other.

It is favorable that the diameter of not less than 80% of particles of the alumina used in the present invention is not more than 1 μm. It is more favorable that the diameter of not less than 50% of the particles thereof is not more than 0.5 μm. By using the alumina whose particles have small diameters, it is possible to disperse them uniformly and hence improve heat dissipation effect and easy to secure the uniformity of the surface of the toner-transporting portion 1.

In addition to the above-described components, the semiconductive rubber composition may contain the following additives unless the use thereof is not contradictory to the object of the present invention: a plasticizing agent, a processing aid, a antidegradant, a filler, a scorch retarder, an ultraviolet ray absorber, a lubricant, a pigment, an antistatic agent, a flame retardant, a neutralizer, a core-forming agent, a defoaming agent, and a crosslinking agent.

As the plasticizer, it is possible to use dibutyl phthalate (DBP), dioctyl phthalate (DOP), tricresyl phosphate, and wax. As the processing aid, fatty acids such as stearic acid can be used. It is preferable that the mixing amounts of these plasticizing components are not more than five parts by mass for 100 parts by mass of the rubber component to prevent bleeding from occurring when the oxide film is formed on the outermost layer of the toner-transporting portion and the electrophotographic photoreceptor from being contaminated when the semiconductive roller is mounted on a printer and the like and when the printer or the like is operated. In this respect, polar wax can be used most favorably as the plasticizer.

As the antidegradant, various age resistors and antioxidants can be used. When the antioxidant is used as the antidegradant, it is preferable to appropriately select the mixing amount thereof to efficiently form the oxide film on the outermost layer of the toner-transporting portion.

The following powdery fillers can be used: zinc oxide, silica, carbon, carbon black, clay, talc, calcium carbonate, magnesium carbonate, aluminum hydroxide, and alumina. The rubber composition containing the filler is allowed to have an improved mechanical strength and the like.

The mixing amount of the filler for 100 parts by mass of the rubber component is favorably not more than 60 parts by mass and more favorably not more than 50 parts by mass. The weakly conductive carbon black and the alumina serve as the filler in addition to the above-described role thereof.

As the scorch retarder, it is possible to use N-(cyclohexylthio)phthalimide; phthalic anhydride, N-nitrosodiphenylamine, 2,4-diphenyl-4-methyl-l-pentene. It is preferable to use the N-(cyclohexylthio)phthalimide. These scorch retarders can be used singly or in combination. The mixing amount of the scorch retarder for 100 parts by mass of the rubber component is favorably not less than 0.1 nor more than 5 parts by mass and more favorably not less than 0.1 parts by mass nor more than 1 part by mass.

The dielectric loss tangent of the semiconductive roller of the present invention is 0.1 to 1.8 when an alternating voltage of 5V is applied thereto at a frequency of 100 Hz. It is possible to impart a high electrostatic property to the toner and maintain the imparted electrostatic property.

The semiconductive roller of the present invention has an electric resistance of 10⁵ to 10⁷ Ω, supposing that a voltage of 100V is applied thereto.

In the present invention, the adherence of the toner to the semiconductive roller is very low, and the toner can be effectively moved by an electrostatic force (Coulomb force). Consequently when the semiconductive roller of the present invention is incorporated in a printer as a developing roller, the transmission density of a printed sheet does not drop even when 5% printing was performed on 2,000 sheets of paper. More specifically, supposing that the transmission density of a first printed sheet of the solid black image is C0 and that the transmission density of a printed sheet of the solid black image after 5% printing was performed on 2,000 sheets of paper is C 2000, C 2000/C0≧1.

### EXAMPLES 1 THROUGH 8 AND COMPARISON EXAMPLES 1 THROUGH 33

Components (numerical values shown in table 1 indicate parts by mass) shown in table 1 were kneaded by a Banbury mixer. Thereafter the kneaded components were extruded by a rubber extruder to obtain a tube having an outer diameter of φ 22 mm and an inner diameter of φ9 mm to φ9.5 mm. The tube was mounted on a shaft having φ8 mm for vulcanizing use. After the rubber component was vulcanized in a vulcanizer for one hour at 160° C., the tube was mounted on a shaft, having a diameter of φ10 mm, to which a conductive adhesive agent was applied. The tube and the shaft were bonded to each other in an oven at 160° C. After the ends of the tube were cut, traverse abrasion was carried out with a cylindrical abrading machine. Thereafter the surface of the tube was abraded to a mirror-like surface finish to set the surface roughness Rz thereof to the range of 3 to 5 μm. The surface roughness Rz was measured in accordance with JIS B 0601 (1994). As a result, a semiconductive roller of each example and comparison example having a diameter of φ20 mm (tolerance: 0.05 mm) was obtained.

After the surfaces of each of the semiconductive rollers was washed with water, the surface thereof was irradiated with ultraviolet rays to form an oxidized layer thereon. By using an ultraviolet ray irradiation lamp (“PL21-200” produced by Sen Lights Corporation), the surface of each semiconductive roller was irradiated, with ultraviolet rays (wavelength: 184.9 nm and 253.7 nm) at intervals of 90 degrees in its circumferential direction for five minutes and with the ultraviolet ray irradiation lamp at 10 cm spaced from the semiconductive roller. Each semiconductive roller was rotated by 90 degrees four times to form the oxide film on its entire peripheral surface (360 degrees).

TABLE 1

| | | Example 1 | Example 2 | Example 3 | Example 4 | Example 5 |
|---|---|---|---|---|---|---|
| Chloroprene rubber | | 65 | 65 | 65 | 65 | 65 |
| Epichlorohydrin copolymer | | 35 | 35 | 35 | 35 | 35 |
| Polyether copolymer | | | | | | |
| Titanium oxide | | 5 | 10 | 20 | 30 | 50 |
| Weakly conductive carbon black | | 40 | 40 | 40 | 40 | 40 |
| Hydrotalcite | | 3 | 3 | 3 | 3 | 3 |
| Powdery sulfur | | 0.5 | 0.5 | 0.5 | 0.5 | 0.5 |
| Ethylene thiourea | | 1.4 | 1.4 | 1.4 | 1.4 | 1.4 |
| Oxide film on outermost layer | | Formed | Formed | Formed | Formed | Formed |
| Dielectric loss tangent | | 0.49 | 0.63 | 0.64 | 0.74 | 0.90 |
| Electric resistance of roller log 100R | | 6.4 | 6.4 | 6.4 | 6.4 | 6.4 |
| Transmission | CO | 1.8 | 1.79 | 1.71 | 1.72 | 1.81 |
| density of | C2000 | 1.8 | 1.89 | 1.85 | 1.82 | 1.85 |
| printed sheet | Change of rate of density | 100% | 106% | 108% | 106% | 102% |
| Charged amount of | TO(μC/g) | 43.0 | 43.2 | 47.9 | 57.1 | 48.2 |
| toner | T2000(μC/g) | 38.2 | 39.1 | 37.9 | 40.0 | 38.2 |

| | | Example 6 | Example 7 | Comparison Example 3 | Comparison Example 4 |
|---|---|---|---|---|---|
| Chloroprene rubber | | 65 | 65 | 65 | 65 |
| Epichlorohydrin copolymer | | 35 | 25 | 35 | 25 |
| Polyether copolymer | | | 10 | | 10 |
| Titanium oxide | | 60 | 20 | — | — |
| Weakly conductive carbon black | | 40 | 40 | 40 | 40 |
| Hydrotalcite | | 3 | 3 | 3 | 3 |
| Powdery sulfur | | 0.5 | 0.5 | 0.5 | 0.5 |
| Ethylene thiourea | | 1.4 | 1.4 | 1.4 | 1.4 |
| Oxide film on outermost layer | | Formed | Formed | Formed | Formed |
| Dielectric loss tangent | | 0.96 | 0.67 | 0.40 | 0.50 |
| Electric resistance of roller log 100R | | 6.4 | 6.0 | 6.4 | 6.0 |
| Transmission | CO | 1.90 | 1.81 | 1.81 | 1.83 |
| density of | C2000 | 1.91 | 1.88 | 1.71 | 1.69 |
| printed sheet | Change of rate of density | 101% | 104% | 94% | 92% |
| Charged amount of | TO(μC/g) | 48.5 | 40.7 | 40.2 | 43.4 |
| toner | T2000(μC/g) | 38.5 | 37.2 | 37.2 | 39.8 |

As the components of the semiconductive roller of each of the examples and each of the comparison examples, the following substances were used:

(a) Rubber Component

Chloroprene rubber; “Shoprene WRT” produced by Showa Denko K.K.
Epichlorohydrin copolymer; “Epion ON301” produced by Daiso Co., Ltd.
   EO (ethylene oxide)/EP (epichlorohydrin)/AGE (allyl glycidyl ether)=73 mol %/23 mol %/4 mol %.
   Polyether copolymer; “Zeospan ZSN8030” produced by Zeon Corporation.
   EO (ethylene oxide)/PO (propylene oxide)/AGE (allyl glycidyl ether)=90 mol %/4 mol %/6 mol %
      (b) Other Components
Titanium oxide: “Kuronos KR310” produced by Titanium Kogyo Inc.
   specific gravity: 4.2. Mainly composed of particles having diameter of 0.3 to 0.5 μm.
Weakly conductive carbon black; “Asahi #15” produced by Asahi Carbon Co., Ltd.
   Average primary particle diameter: 120 nm
   DBP oil absorption amount: 29 ml/100 g
   Iodine absorption amount: 14 mg/g
Hydrotalcite (acid-accepting agent): “DHT-4A-2” produced by Kyowa Chemical Industry Co.,Ltd.
Powdery sulfur (vulcanizing agent)
Ethylene thiourea (vulcanizing agent): “Accel 22-S” produced by Kawaguchi Chemical Industry Co.,Ltd.

The characteristics of the semiconductive rollers of the examples and the comparison examples were measured as described below. Table 1 shows the results.

Measurement of Electric Resistance of Roller

To measure the electric resistance of each roller, as shown in FIG. 2, a toner-transporting portion 1 through which the metal shaft 2 was inserted was mounted on an aluminum drum 13, with the toner-transporting portion 1 in contact with the aluminum drum 13. A leading end of a conductor having an internal electric resistance of r (100 Ω) connected to a positive side of a power source 14 was connected to one end surface of the aluminum drum 13. A leading end of a conductor connected to a negative side of the power source 14 was connected to other-side end surface of the toner-transporting portion 1.

A voltage V applied to the internal electric resistance r of the conductor was detected. Supposing that a voltage applied to the apparatus is E, the electric resistance R of the roller is: R=r×E/(V−r). But the term of −r is regarded as being extremely small, R=r×E/V. A load F of 500 g was applied to both ends of the metal shaft 2. A voltage E of 100V was applied to the roller, while it was being rotated at 30 rpm. The detected voltage V was measured at 100 times during four seconds. The electric resistance R was computed by using the above equation. The measurement was conducted at a constant temperature of 23° C. and a constant humidity of 55%.

In table 1, the electric resistance is shown by log 100R.

Measurement of Dielectric Loss Tangent of Roller

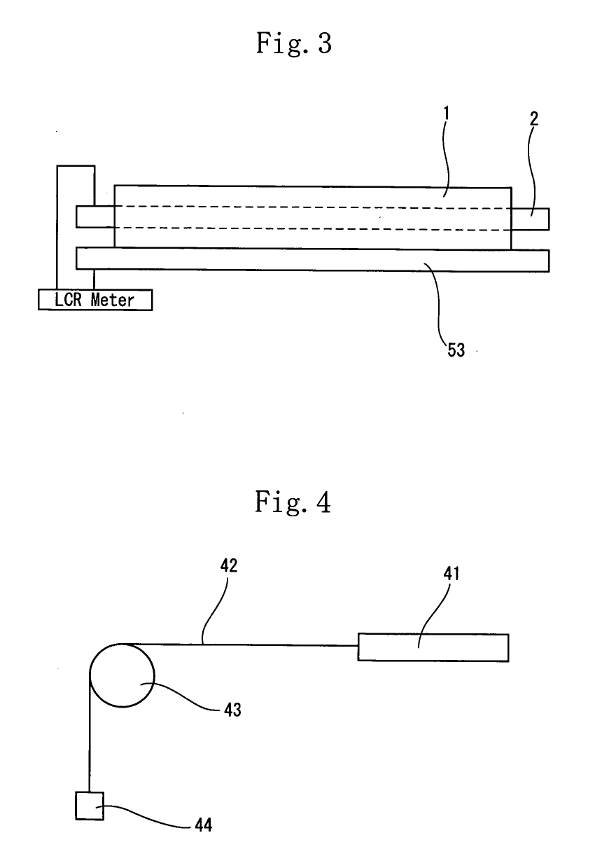

As shown in FIG. 3, an alternating voltage of 100 Hz to 100 kHz was applied to the toner-transporting portion 1, with the metal shaft 2 and a metal plate 53, serving as an electrode respectively, on which the toner-transporting portion 1 was placed. An R (electric resistance) component and a C (capacitor) component were measured separately by an LCR meter (AG-4311B, manufactured by Ando Electric Co., Ltd) at a constant temperature of 23° C. and a constant humidity of 55%. The dielectric loss tangent was computed from the value of R and C by using the following equation.
Dielectric loss tangent (tan δ)=G/(ωC), G=1/R

The dielectric loss tangent is computed as G/ωC, when the electrical characteristic of one roller is modeled as a parallel equivalent circuit of the electric resistance component of the roller and that of the capacitor component thereof. In this example, the value of the dielectric loss tangent is set when an alternating voltage of 5V is applied to the semiconductive roller at a frequency of 100 Hz. The reason a low voltage of 5V is applied to the semiconductive roller is because the toner shows a behavior close to a voltage fluctuation generated when the toner shifts from the developing roller to the next process, namely, the electrophotographic photoreceptor.

In this example, the dielectric loss tangent is adjusted to 0.5 to 1.0.

Evaluation of the Adherence of the Toner to the Semiconductive Roller

To examine the adherence of the toner to the semiconductive roller, the semiconductive roller of each of the examples and the comparison examples was mounted on a laser printer (commercially available printer in which unmagnetic one-component toner is used) as a developing roller. The performance of each semiconductive roller was evaluated by setting a change of a toner amount outputted as an image, namely, a change of the amount of the toner deposited on a printed sheet as the index. The amount of the toner deposited on the printed sheet can be measured by measuring a transmission density shown below.

More specifically, after a black solid image is printed, the transmission density is measured with a reflection transmission densitometer (“Techkon densitometer RT120/light table LP20 produced by TECHKON Inc.) at given five points on each of obtained printed sheets. The average value of the measured transmission densities was set as an evaluation value (indicated as (“C0”) in table 1).

In a manner similar to the above-described manner, the transmission density was also measured on a sheet printed the black solid image after 5% printing was performed on 2,000 sheets of paper. The average value of the measured transmission densities was set as an evaluation value (indicated as (“C 2000”) in table 1). The reason the transmission density was measured after 2,000 sheets of paper was printed is because break-in is finished, when printing is carried out on 2,000 sheets of paper.

The change of rate (%)=C 2000/C0 was computed from obtained values.

Evaluation of Charged Amount of Toner

Evaluation of the charged amount of the toner was made as described below to examine whether a change of the charged amount of the toner affected the change of the transmission density of the printed sheet measured by the above-described manner.

More specifically, after a white solid image (white paper) was printed, a cartridge was removed from a laser printer. Thereafter toner was absorbed from above from a developing roller mounted on the cartridge by charged amount-measuring machine of absorption type (“Q/M METER Model 210HS-2 produced by Treck Inc.) to measure a charged amount (μC) and a toner weight (g). The amount of static electricity per weight was computed (indicated as “T0” in table 1) as the charged amount (μC/g) of the toner. That is, charged amount (μC/g) of toner=charged amount (μC)/weight (g) of toner.

The white solid image (white paper) was printed on 2,000 sheets of paper. Thereafter the charged amount (indicated as “T 2000” in table 1) of the toner was measured in a manner similar to the above-described manner.

It is known that the more the toner is used, the lower is the charged amount of the toner and the higher is the amount of the toner deposited on the printed sheet, i.e., the higher is the transmission density of the printed sheet. The reason this phenomenon occurs is as follows: The difference between the potential of the developing roller and that of the electrophotographic photoreceptor is compensated by the charged amount of the toner, and the above-described potential difference is proportional to the charged amount of the toner, namely, charged amount (μ/g) of toner×weight (g) of toner. Therefore so long as the difference between the potential of the developing roller and that of the electrophotographic photoreceptor is constant, the weight of the toner increases when the charged amount of the toner decreases.

In the comparison examples 1 and 2, although the charged amount of the toner decreased to some extent, the transmission density of the printed sheet did not increase but decreased. This is because a part of the toner adhered to the developing roller.

On the other hand, in the examples 1 through 7, the transmission density of the printed sheet increased. It could be confirmed that unlike the comparison examples 1 and 2, a phenomenon that the toner adhered to the developing roller did not occur.

What is claimed is:

1. A semiconductive roller comprising a toner-transporting portion whose outermost layer is formed essentially of resin or rubber, wherein said resin or said rubber includes resin or rubber having chlorine atoms and 3 to 60 parts by mass of titanium oxide for 100 parts by mass of said resin or said rubber having said chlorine atoms.

2. The semiconductive roller according to claim 1, which is ionic-conductive.

3. The semiconductive roller according to claim 1, wherein said resin or said rubber composing said outermost layer further contains a dielectric loss tangent-adjusting agent; and a dielectric loss tangent of said semiconductive roller is set to a range of 0.1 to 1.8, when an alternating voltage of 5V is applied thereto at a frequency of 100 Hz.

4. The semiconductive roller according to claim 2, wherein said resin or said rubber composing said outermost layer further contains a dielectric loss tangent-adjusting agent; and a dielectric loss tangent of said semiconductive roller is set to a range of 0.1 to 1.8, when an alternating voltage of 5V is applied thereto at a frequency of 100 Hz.

5. The semiconductive roller according to claim 1, wherein an oxide film is formed on a surface of an outermost layer of a toner-transporting portion.

6. The semiconductive roller according to claim 2, wherein an oxide film is formed on a surface of an outermost layer of a toner-transporting portion.

7. The semiconductive roller according to claim 3, wherein an oxide film is formed on a surface of an outermost layer of a toner-transporting portion.

8. The semiconductive roller according to claim 1, wherein said resin or said rubber having said chlorine atoms essentially includes chloroprene rubber.

9. The semiconductive roller according to claim 1, wherein said resin or said rubber having said chlorine atoms essentially includes an epichlorohydrin copolymer.

10. The semiconductive roller according to claim 1, which is used as a developing roller for use in a developing apparatus, using an unmagnetic one-component toner, which is mounted in an image-forming mechanism of an electrophotographic apparatus.
